(19) United States
(12) Patent Application Publication
(10) Pub. No.: US 2016/0267478 A1
(43) Pub. Date: Sep. 15, 2016

(54) METHOD AND APPARATUS FOR PAYING FOR WEB CONTENT, VIRTUAL GOODS AND GOODS OF SMALL VALUE

(71) Applicant: MICROPEBBLES INC., Toronto (CA)

(72) Inventors: Stanley CHOW, Ottawa (CA); Ross HOUGH, Toronto (CA)

(21) Appl. No.: 15/031,901

(22) PCT Filed: Oct. 24, 2014
(86) PCT No.: PCT/CA2014/000758

§ 371 Date: Apr. 25, 2016

(30) Foreign Application Priority Data
Oct. 25, 2013 (CA) 2,830,855

(51) Int. Cl. G06Q 20/38; G06Q 20/40

(52) U.S. Cl. CPC G06Q 20/38215; G06Q 20/40; G06Q 20/405

(57) ABSTRACT

The subject application relates to electronic commerce (i.e. e-commerce or e-payment) technology and more particularly, to a method and system for paying for items of small value including web content and virtual goods, over communication networks such as the Internet. One embodiment described is directed to a method of electronic payment between a payer and a payee comprising generating a secure electronic transaction by a payer device, the secure electronic transaction including a certificate having an extension setting out transaction rules. The secure electronic transaction is routed through a selected payment path of network entities from the payer device to a payee device, a network entity on each layer of a hierarchy in the path adding a respective certificate to the secure electronic transaction, along with respective extensions setting out transaction rules. Other aspects of the invention are also described, such as how to determine a selected path.

### CROSS-REFERENCE TO RELATED APPLICATIONS

This is the U.S. National Phase application under 35 U.S.C. §371 of International Patent Application No. PCT/CA2014/000758 filed Oct. 24, 2014, which claims the benefit of Canadian Patent Application Serial No. 2,830,855 filed on Oct. 25, 2013. The contents of which are incorporated herein by reference.

### FIELD OF THE INVENTION

The subject application relates to electronic commerce (i.e. e-commerce or e-payment) technology and more particularly, to a method and system for paying for items of small value including web content and virtual goods, over communication networks such as the Internet.

### BACKGROUND

There is currently a demand for a method and apparatus for paying for “slices of media” and/or items of small value including web content and virtual goods over the World Wide Web. Web content could be anything from research papers, industry specific published material, blogs, newspapers, magazines, specialty groups, etc., to even pay per view video or live broadcasts. In the video game market for example, consumers create their own games complete with virtual worlds and buy virtual goods ranging from customized sports cars to eyelashes for a particular character within the game.

By way of background, the World Wide Web (amongst other mechanisms) makes it possible to find and purchase all sorts of web content and a variety of virtual goods. However, there are many difficulties with the current purchasing methods. For example: 1) lack of truly “frictionless” solutions to make payments as easy as taking a coin out of ones pocket to pay for a paper at a corner store. Today's payment systems are typically cumbersome and have a disproportionately high down-side risk, i.e., do you really want to take out your credit card and enter your number to buy one newspaper? The level of work required is too high relative to the size of the transaction and will typically scare away consumers; 2) cross border purchases are difficult if not impossible: a North American consumer can easily purchase from a North American seller but it becomes increasingly difficult once you cross national boundaries, i.e., international sellers do not have the same payment options, some countries almost impossible to buy anything from today; 3) not everyone supports multi-currency; 4) ensuring local law & regulatory compliance; 5) putting in systems to prevent money laundering or other illegal activity; 6) most systems are credit card based and inherently have very high charges relative to the size of payments, i.e., charges on a $20 transaction consumers and/or sellers have learned to accept the fees but once the transaction size drops to a dollar or less it becomes not only irritating but in some cases impossible to make a profit; and 7) lack of ways to consolidate unused assets for small purchases, i.e., there is $16B US in unused loyalty currency for example.

EARLY HISTORY OF MICROPAYMENTS: There have been many attempts at providing e-payment systems by companies both large and small. In the 90's, both Digital Equipment Corporation (DEC) with Millicent circa 1995 (acquired by Compaq) and IBM Micro Payments circa 1999 were early players in this space. These first generation systems were ecash, digital cash or etokens and were predominantly anonymous and untraceable for the most part. All of the first generation companies failed after trial or were left solely as theoretical projects.

The second generation of micropayment systems between 1999-2004 were primarily account based allowing the transfer of money from customer accounts to merchants accounts similar to banking. It has been proposed that there were a couple of reasons the big companies failed: 1) the market for epayments was still in its infancy, i.e., PayPal just started around 1998 and people had yet to embrace this payment method in a big way and had yet to trust the Internet and 2) in typical big company fashion, companies like DEC & IBM were trying to “own it all” and not let others benefit and/or participate in the ecosystem.

TODAY'S LARGE COMPETITORS: Google, Apple, PayPal & Amazon (i.e. the ‘big 4’) are the big companies that currently support micropayments but without exception are dependent on credit card companies and therefore are subject to their high fees. For example, a one dollar transaction could cost between 1.5% to 2.9% or more, plus $0.10 to $0.30, which starts to become prohibitively expensive for low value transactions. In addition, if the transaction involves a currency exchange it could add 1.0% to 3.0% in additional charges, and is only the beginning of the fees. In addition, Google Play and Apple iTunes also charge large fees to sell content, apps, etc. ranging from 10-30%. Amazon & PayPal charge 5% and $0.05 per transaction.

As a matter of overview, the problems with the ‘big 4’ include the following:
None of the big 4 are frictionless: all of them require several clicks to perform a purchase;
Costs: costs are disproportionately high;
Alternate ways to input currency into the system are not provided: existing systems do not allow users to leverage loyalty currency as well as direct carrier billing;
Not Truly Global: these existing systems do not provide global support to the extent that they do not support all purchasers world-wide, in any currency, possibly using loyalty currencies;
Inherent Auction Capabilities are not provided;
Control over advertising content is not provided;
Poor control over fraud: most attempts at addressing online fraud today are post sale, i.e., deal with the fraud issue after it already happens, which has proven to be ineffective; and
Limited Ecosystem: existing systems are focused on providing closed, limited systems which neither have a global system for the purchase of global content and virtual goods, nor allow access by arbitrary vendor partners as well as financial partners.

LARGE CREDIT CARD COMPANIES: Both Visa and American Express have had limited success in this space. Visa had a short-lived attempt via Payclick launched in Australia in 2010 but has since withdrawn their offering. Amex has their Serve prepaid card product, which is not really a micropayment solution per se.

MEDIUM SIZED COMPETITORS: Iowa based Dwolla is an Automated Clearing House (ACH) and has created a network outside of the current banking network. Their fees are very low to transfer money: under $10.00 is free and there is a flat $0.25 charge for any amount greater than $10.00. Paris based company HiMedia, is a payment provider, content publisher and ad network. A San Francisco based company Paymentwall offers the ability to monetize content for 5% plus credit card fees. In addition, they can also support direct carrier billing, prepaid, bank transfer and direct debit transfer. German based company Micropayment is very similar to Paymentwall as well.

But all of the players in the medium-sized competitors still have problems which are not addressed:
Still no frictionless players in this space;
Very few that can offer solutions outside of their own geography or not global;
No support for Loyalty currencies;
None that provide complete control over advertising paths and revenue; and
Their solutions are either: 1) Proprietary or 2) still rely heavily on credit card network or 3) geo centric carriers.

MOBILE DEVICE: DIRECT CARRIER, BANKING & THIRD PARTY SOLUTIONS: There are many carriers and/or banks that are partnering together within relatively geo centric zones to offer mobile purchasing solutions. Consumers are capable of buying via: 1) SMS or texting, direct mobile billing to a customer's account (typically with a PIN number), 2) WAP (Wireless Application Protocol) which in most cases are either tied to credit card, PayPal or customers carrier billing, 3) Near Field Communication (NFC) devices usually for in store purchases, 4) Cloud based solutions which typically still require NFC hardware (Google, PayPal), & 5) Bank/Operator solutions.

The NFC solutions and their challenges are not really relevant as they are not tailored to online transactions, i.e., they are more focused on bricks and mortar shopping. The drawbacks to the other solutions include the following: 1) they still require credit cards or traditional banking relationships and therefore are subject to high fees, 2) SMS and direct billing solutions also charge high fees to vendors, 3) they do not offer customers any ability to leverage alternate currencies such as loyalty currencies or coupons 4) in the case of SMS there is no audit trail for customers to reconcile or track their purchases, 5) they still require multiple steps to purchase items and therefore are not frictionless, and 6) they are typically geocentric and do not have a large enough footprint to offer global micropayments.

SMALLER COMPANIES: Virtually all of the smaller companies in this space require Payment Processors (such as PayPal and Google) and Credit Card Companies, and therefore fees run in the 2.9% plus $0.30 per transaction. Many of these services fall somewhere between shopping carts and turnkey marketplaces. Some of the companies that fall into this category are Payloadz ($14.95 per month plus 5% transaction fee), Shopify (minimum $29 per month plus credit card fees), Volusion (minimum $15 per month plus fees), FetchApp ($5.00-$500 per month plus fees), Quixly ($10 per month plus fees), ClickBank (7.5% per transaction plus $1.00), Pulley ($6-$299 per month) and E-junkie (minimum $5 per month plus fees). Many of these companies host the content and charge monthly fees. The range of fees and associated charges range from about 6-8% for low bandwidth content while higher bandwidth content such as video could cost over 12%. Relatively newcomer Gumroad does not require a payment processor but still requires credit cards for payment. Gumroad charges a fixed fee of $0.30 plus 5% for each sale. All of these are expensive systems with very limited flexibility as they are designed for a narrow and specific purpose.

SOCIAL MEDIA & GAME CARD COMPANIES: Social Media companies such as Facebook are also starting to get in the game with virtual currencies although their main focus to date has been solely online games. Another company, Flattr, has made it possible to attach money to your “likes” on Facebook for example. There are also hundreds of game card solutions.

The current Social Media and game card solutions have problems including the following:
Most game cards are not transferable and therefore have limited use, i.e., they cannot be used across games from several manufacturers, or for other purposes such as buying newspapers, movies, etc.;
Cards are still not frictionless and still require several clicks to buy items;
No opportunity for vendors to leverage cross platform purchasing/advertising data;
Typically not global;
No opportunity to leverage global loyalty currencies; and
Do not provide effective fraud protection and granular control of limits.

There is therefore a need for an improved method and system for paying for small, virtual and other goods in an electronic environment.

### SUMMARY OF THE INVENTION

It is an object of the invention to provide an improved method and system for paying for small, virtual and other goods in an electronic environment, which mitigates upon the problems described above.

One embodiment of the invention is directed to a method of electronic payment between a payer and a payee comprising: generating a secure electronic transaction by a payer device, the secure electronic transaction including a certificate having an extension setting out transaction rules; routing the secure electronic transaction through a payment path of network entities from the payer device to a payee device, particular ones of the network entities adding a respective certificate to the secure electronic transaction, each of the respective added certificates having an extension setting out transaction rules; and receiving the secure electronic transaction at the payee device, including the certificates from each of the network entities in the payment path.

A second embodiment of the invention is directed to a system for electronic payment between a payer and a payee comprising: a payer device; a payee device; and a network interconnecting the payer device and the payee device; the payer device being operable to: generate a secure electronic transaction, the secure electronic transaction including a certificate having an extension setting out transaction rules; and route the secure electronic transaction through a payment path of network entities from the payer device to a payee device, over the network, particular ones of the network entities adding a respective certificate to the secure electronic transaction, each of the respective added certificates having an extension setting out transaction rules; and the payee device being operable to receive the secure electronic transaction, including the certificates the particular ones of the network entities in the payment path.

Other aspects and features of the present invention will be apparent to those of ordinary skill in the art from a review of the following detailed description when considered in conjunction with the drawings.

### DESCRIPTION OF THE DRAWINGS

The present invention exists in the construction, arrangement, and combination of the various parts of the device, and steps of the method, whereby the objects contemplated are attained as hereinafter more fully set forth, specifically pointed out in the claims, and illustrated in the accompanying drawings in which:

FIG. 1 is an example to show how a consumer would be connected to a content provider (in this case, the Wall Street Journal);

FIG. 2 shows the message flow for the initial set up, the consumer receiving a “coupon” from her ISP (Internet Service Provider);

FIG. 3 shows the message flow for the consumer asking for a web page and the WSJ sends back a request for payment instead of the page—with the information for the banks that know about WSJ;

FIG. 4 shows the message flow that the consumer uses to ask CH1 (Clearing House 1, the clearing house for her ISP) for paths to Bank2 and Bank3;

FIG. 5 shows the calculation for each path resulting in the exact cost for using that path (that is, sending the payment through each entity along that path);

FIG. 6 shows the choices being presented to the consumer—in effect, an auction is being conducted instantaneously with the ultimate choice up to the consumer. After the choice is made (through the ISP in this case) the message flow is shown for the consumer to ask her ISP to certify the payment;

FIG. 7 finally shows the stage where the consumer can send proof payment to WSJ (the content provider) and receive the page;

FIG. 8 shows the hierarchy of Clearance Houses—each acting as a guarantor of payment for its descendants;

FIG. 9 shows the details of a certificate;

FIG. 10 shows how paths are calculated;

FIG. 11 shows what returned path looks like (with ad URL);

FIG. 13 shows an exemplary model for a Coupon;

FIG. 14 shows a flow chart for an exemplary method of purchase execution;

FIG. 15 shows a flow chart for an exemplary method of purchasing for an ISP subscriber;

FIG. 16 shows a flow chart for an exemplary method of purchasing for a professional association member; and

FIG. 17 shows a detailed flow chart for an exemplary method of purchasing.

### DETAILED DESCRIPTION

Several embodiments or implementations of the various aspects of the present disclosure are hereinafter illustrated and described in conjunction with the drawings, wherein like reference numerals are used to refer to like elements. In several embodiments, the various aspects of the present disclosure find particular utility in transactions over the World Wide Web using the HTTP (Hyper Text Transfer Protocol) in examples; but it is clear that many other protocols (standard or proprietary) can be used.

Similarly, the examples described use web pages as the purchased good but it could just as well be in-game objects (like a valued sword in a game), discount coupons or anything that can be represented by bits of data.

Also, X.509 certificates are used in these examples; this is only for convenience since X.509 is wide used. Any other cryptographic signature scheme can be used instead.

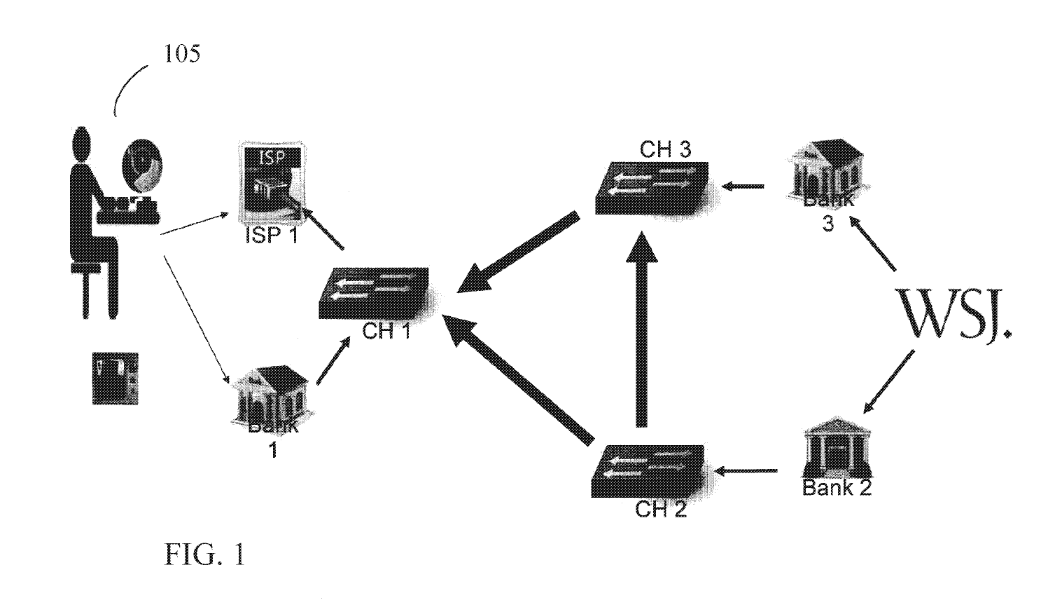

Referring now to the drawings wherein the showings are for purposes of illustrating the exemplary embodiments only and not for purposes of limiting the claimed subject matter, FIG. 1 provides a payment system where a consumer can pay money to the provider (in this case the WSJ). Usually, there will be many “paths” for the money to flow. In FIG. 1, some possible paths are as follows (ISP representing ‘Internet Service Provider’, CH representing ‘Clearing House’, and WSJ representing ‘Wall Street Journal’):

1) consumer->ISP1->CH1->CH3->Bank3->WSJ,

2) consumer->Bank1->CH1->CH2->Bank2->WSJ, or even

3) consumer->ISP1->CH1->CH2->CH3->Bank3->WSJ.

We refer to ISP1, Bank1, Bank2, and Bank3 as Payment Authorities (PAs). Each PA can handle paying (and receiving) money on behalf of clients (the consumer or providers like WSJ). In some contexts, we refer to CH1 as the parent of ISP1 and of Bank1, and to ISP1 as parent of the Consumer, and to CH1 as grand-parent of the consumer.

As depicted in FIG. 1, in a typical scenario, the consumer 105 browses the web with her ISP (ISP1) providing connectivity. She clicks on a link to WSJ (perhaps the link comes as the result of a search, or is a referral from another web page, that is irrelevant). The problem that we address is how can WSJ ask for payment, and for her to pay the requested amount, and to do all of this in a “frictionless” way, even for cross-border, multi-currencies.

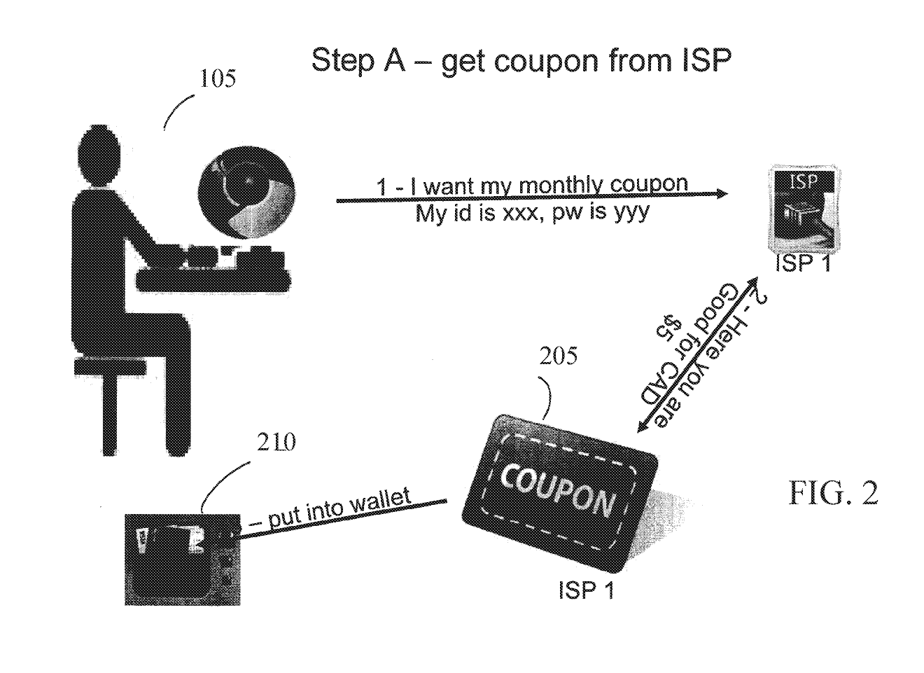

Referring also to FIG. 2, the consumer 105 joins the system initially by getting a “coupon” 205 from her ISP1 (and each other Payment Authority with whom she has agreements). When she provides satisfactory credentials (each Payment Authority can of course choose whatever they want—be in userid/password, one time passwords from hardware authentication tokens, etc.), a coupon 205 will be sent back and put into her e-wallet 210. The e-wallet can be any e-wallet 210 that is supported by her browser. The coupon 205 will be cryptographically signed and refers CH1 as the Guarantor of the payment if ISP1 defaults on the payment. The ISP can also put other information into the coupon 205—for example, this consumer has signed up for a CA$5.00 per month package.

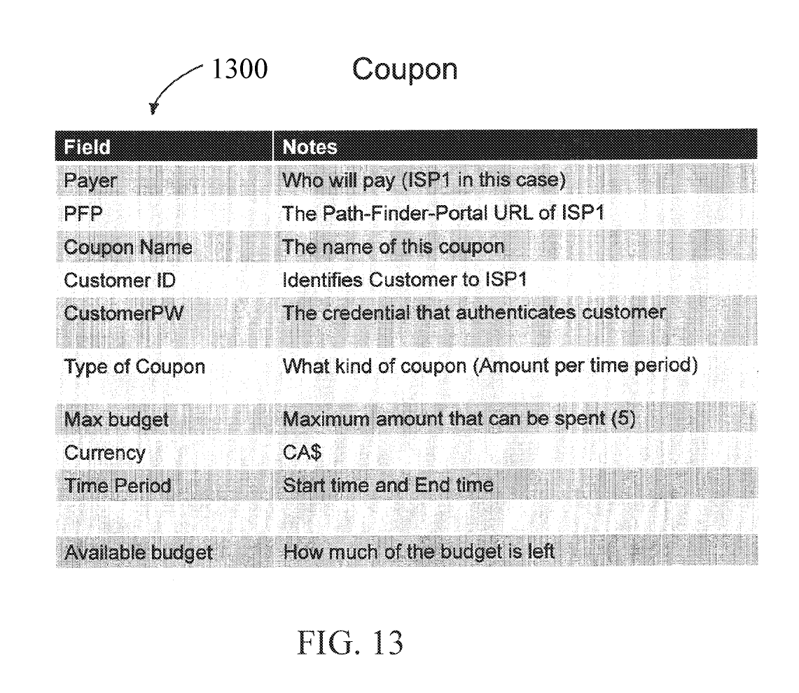

Referring to FIG. 13, the Coupon file 1300 has fields that identify the Customer 105 to the Payer (ISP1) in this case. The PFP field is an URL that the customer 105 can use to find paths (that ISP1 is involved) along with any path adjustments that are needed (in case ISP1 does not want to provide PFP, and uses PFP of CH1 instead), also a name that identifies the coupon to the customer (in this case, something like “Monthly $5 from ISP1”). There is also a description of the type of coupon (in this case a CA$5 for a month). The customer (or more accurately, the customer's browser) can maintain some fields like Available Budget to track how much of the budget has not been spent.

The types of coupon can vary widely—from different currencies to loyalty points to subscriptions (X accesses in a Time Period) to special deals for free access or advertising deals to whatever. The user extension portion can also vary widely—from just keeping of budget left to keeping a complete history of purchases under this coupon.

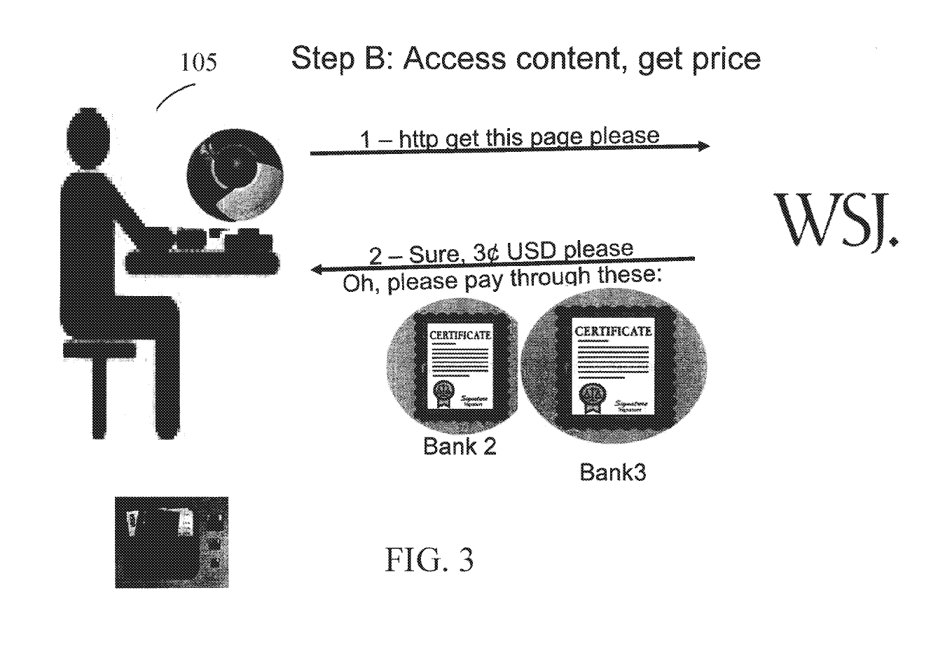

With reference to FIG. 3, the consumer 105 initiates the transactions by clicking on the WSJ link (1). In HTTP, this initiates functionality something like a “get item-URL” where “get” requests a web-page and “item-URL” identifies the exact item of purchase. Recall that HTTP specifies return IP, desired language[s], desired format[s] and other information.

The WSJ web server then goes through whatever business logic to decide (potentially dynamically based on time, user, etc.) whether to charge, and how much to charge. Assuming the decision is to charge 3 cents, then a request for payment is sent back. In HTTP, this can be done as status code 402 that is reserved for payment required or status code 401 that is used for authentication. In either case, the WSJ web server may define the format for the amount, the currency, and information on how the payment must be processed. In this case, WSJ has specified that the payment must be processed through Bank2 or Bank3. This is purely dictated by which banks or other Payment Authorities that WSJ picks. WSJ may obtain the bank information in a process that is similar to FIG. 2. Note that there are many occasions where WSJ may send back a list of prices with conditions for each price. Along with the prices, WSJ may send back a list of PAs that it deals with (in this case Bank2 and Bank3).

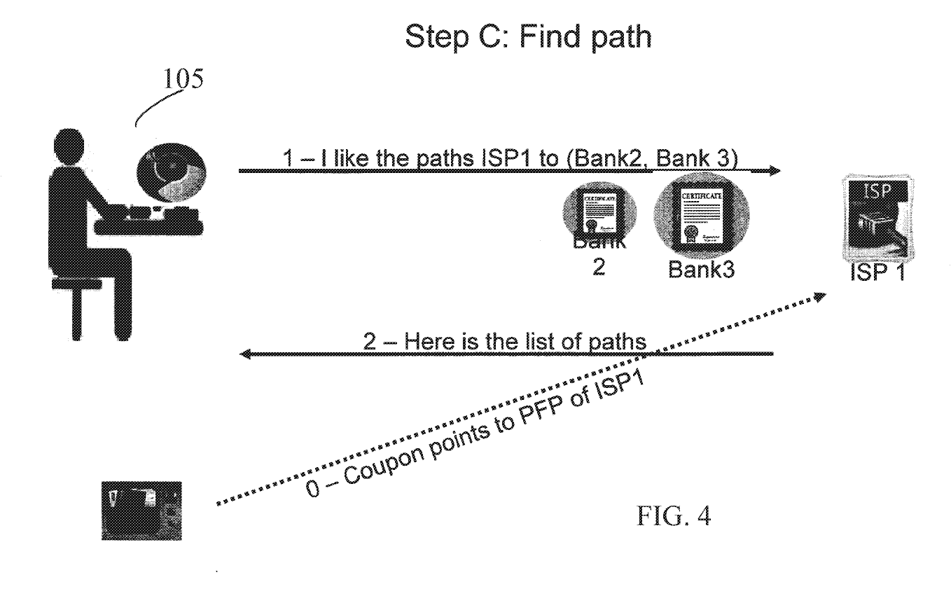

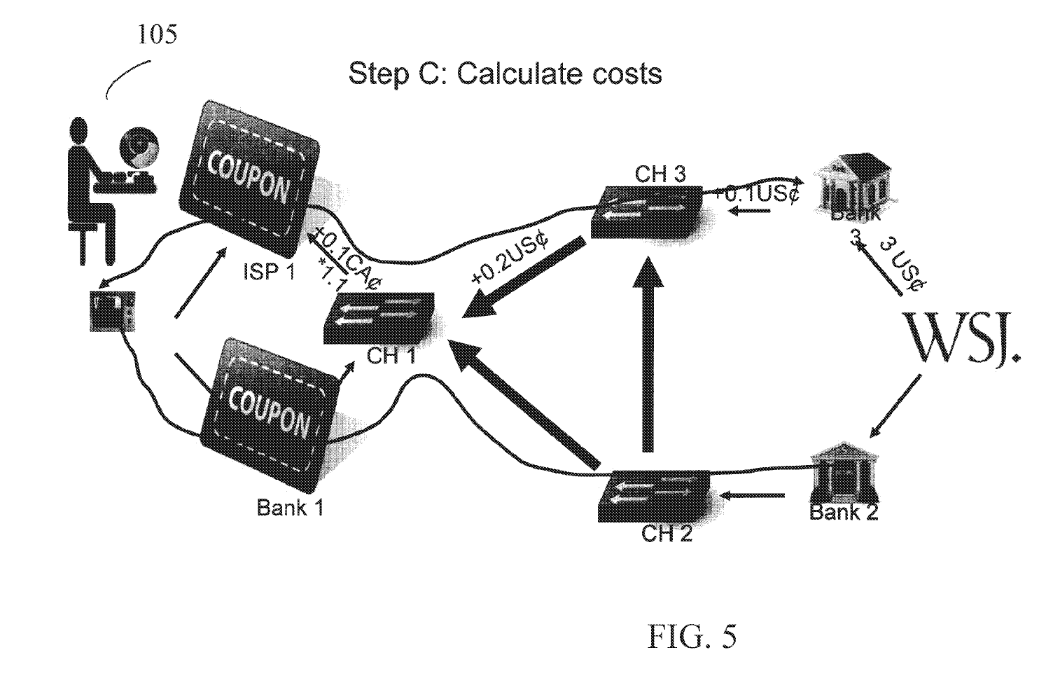

With reference to FIG. 4, the consumer 105 now knows how much to pay, but needs to find a way to pay—that is, she needs to find a chain of entities that will pass the payment from her to WSJ. This is done by asking the “Path-finder” function of some entity, to determine the available payment path or paths between her and the WSJ. This is typically done by a browser extension; the browser extension looks in the coupon 205 for ISP1 to find the PFP URL, then asks the PFP for the list of paths. She sends the list of desired targets (Bank2 and Bank3) to ISP1. ISP1 then returns a list of paths that can go from ISP1 to Bank2 or Bank3. (Note that each path can only end at one of Bank2 or Bank3, but wildcard notation may be useful to indicate a path may reach all the target endpoints.) The path information that is returned includes the chain of nodes as well as the fee schedule for each node. The fee schedule for a node can be as simple as a constant amount or could be computed based on the charge amount and currency-conversion fees.

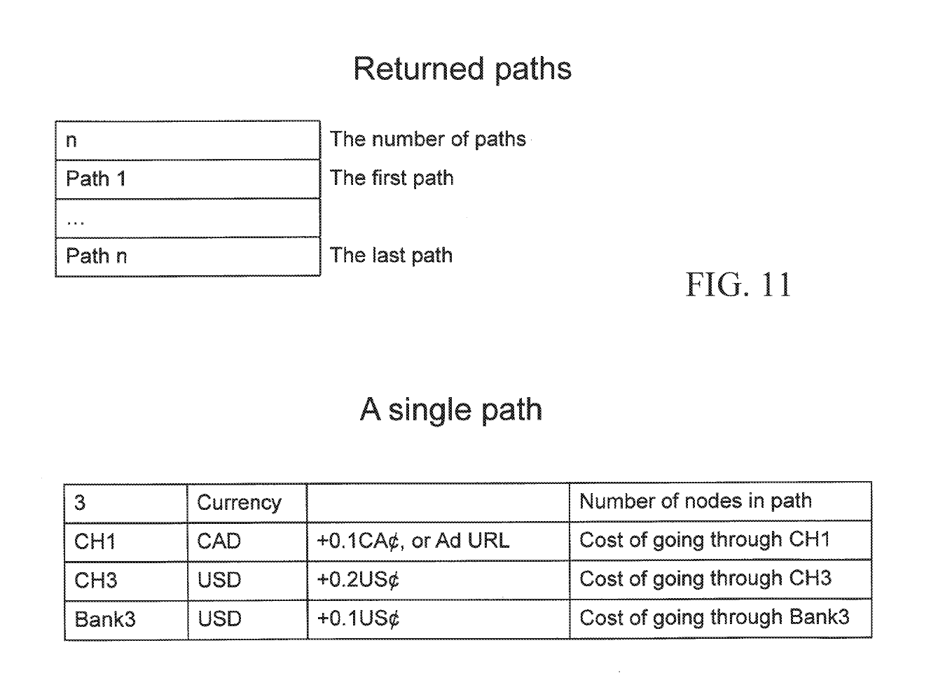

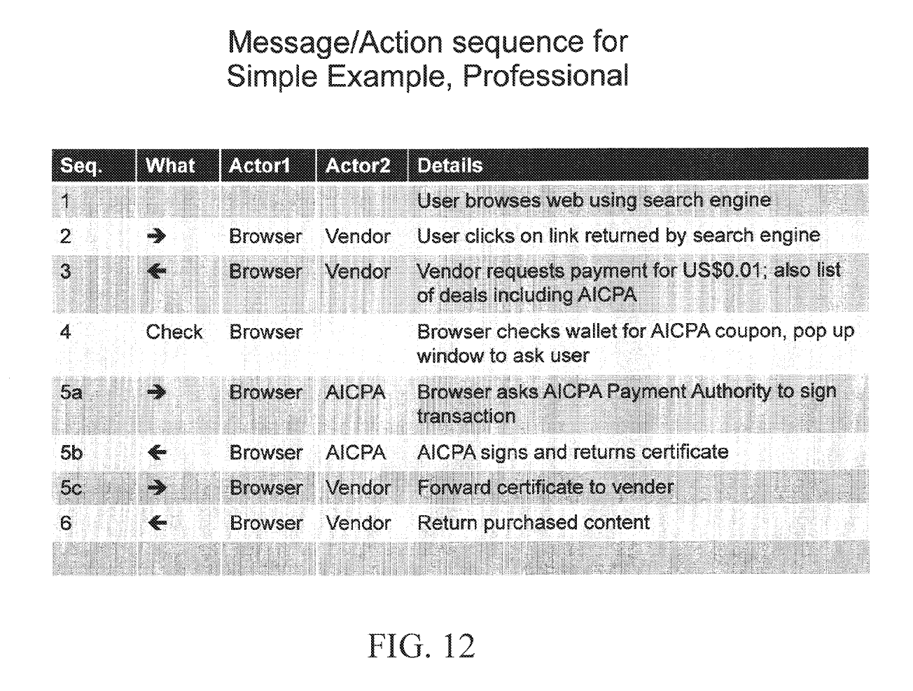

FIG. 11 shows how the paths are returned. Each path consists of a number of nodes and each node will specify what is the cost/fee for using that node as well as currency entering/exiting that node. Each node must have a globally unique identifier. Any numbering/naming scheme can be used such as ASN.1, or UUID (see http://en.wikipedia.org/wiki/Globally_unique_identifier), but the simplest is just to use the domain name. Since each node must have a presence on the Internet, a domain name is required anyway and DNS maintains uniqueness. The fee is the income for that node and includes the cost of operating that node plus profit. The fee can be specified as a fixed price as in the examples here, or it could be a percentage, or any formula. In addition, the cost could be an advertisement in the form of an URL (Universal Resource Locator) like HTTP://mydomain.com/advertPage. Further, the cost could be satisfied by a special deal URL that will make an offer to the consumer; if the consumer accepts the deal, the desired transaction will be completed with no payment.

In this example, the path is relative to ISP1, it implicitly contains ISP1 at the beginning. It is optional whether ISP1 is explicitly in the path. In both cases, the same processing is performed. The PA (in this case ISP1) can also check that its Parent is indeed the next node.

Typically, for efficiency reasons, it is expected that CH1 will pre-computed the paths as opposed to computing the paths on request. So it is natural to just have the fee schedule in the path information and the consumer can easily compute the cost for each path. An example described hereinafter follows this design. An alternative design is for the consumer to send the payment details along in the path request, in which case CH1 can perform the calculation on behalf of the consumer 105 and send back the results.

With reference to FIG. 5, the consumer 105 will now use the fee schedule of each node to calculate the costs along each path. Alternatively, CH1 may have done this calculation ahead of time. In either case, the consumer 105 now has all the details of the transaction in that she knows each entity along the path, and the amount/currency that each entity is charging along the way. This information may be useful for complying with various local or tax law requirements and should be passed along to each entity involved in this transaction. In this example, WSJ asks for US¢3, Bank3 adds US¢0.1, CG3 adds US¢0.2, CH1 converts to CA$ at 1.1, then adds CA¢0.1; so the total cost is (3+0.1+0.2)*1.1+0.1=3.3*1.1+0.1=CA¢3.73 to the consumer 105.

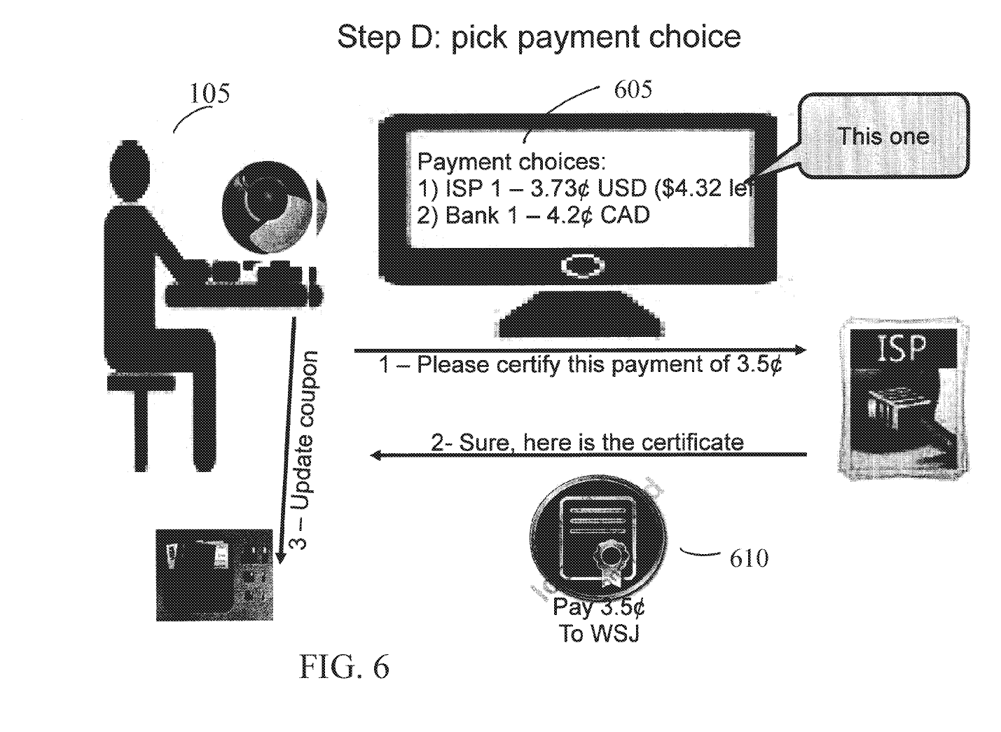

With reference to FIG. 6, her browser will pop up a window 605 showing the choices that she has to pay. In this case, she has two choices: ask her ISP1 to pay the CA¢3.73 out of the CA$5.00 (of which CA$4.9627 is left), or ask her Bank1 to pay CA¢4.2 (using a similar calculation, except that a bank fee has been added). Note that there is no difficulty in using fractions of a cent, truncating or rounding-off such calculations, although the signed transaction should state which approach has been used. In this simple auction, she picks the cheaper choice of using the month package from her ISP1. Her browser will then send the details of the payment (including the path, charges of each entity, details about the item being purchased) to her ISP1. ISP1 will then perform whatever authentication and authorization is required (this can be quite arbitrary to confirm with local laws or any company guidelines, etc.) If the payment is authorized, ISP1 will cryptographically sign the payment and send the certificate 610 back to the consumer 105. Consumer 105 can update her coupon 205 to indicate that another 3.73 cents have been spent.

As with any other payment system, it is desirable to deal with rogue entities that try to cheat. For example, the agreement between CH1 and ISP1 may limit the amount the ISP1 may pay per day. If ISP1 “goes rogue” and signs more certificates there is a problem. This problem is alleviated by allowing each entity to include instructions on how to confirm payment. This allows CH1 to include in the ISP1 certificate that the payee will have to contact CH1 to confirm payment. Obviously, it may not be desirable for each entity to want to confirm each transaction—the overhead would kill the efficiency; so we allow the instruction to include things like: if this ISP has already certified 100 transactions today to this payee then each transaction must be confirmed, otherwise (for the first 100 transactions) randomly confirm 1% of the transactions. The random choices could be made by hashing together the details of the transaction to form a random number. Typically, content providers like WSJ are not expected to write the code to perform these checks, they would call a library or use HTTP to ask a server provided by their bank.

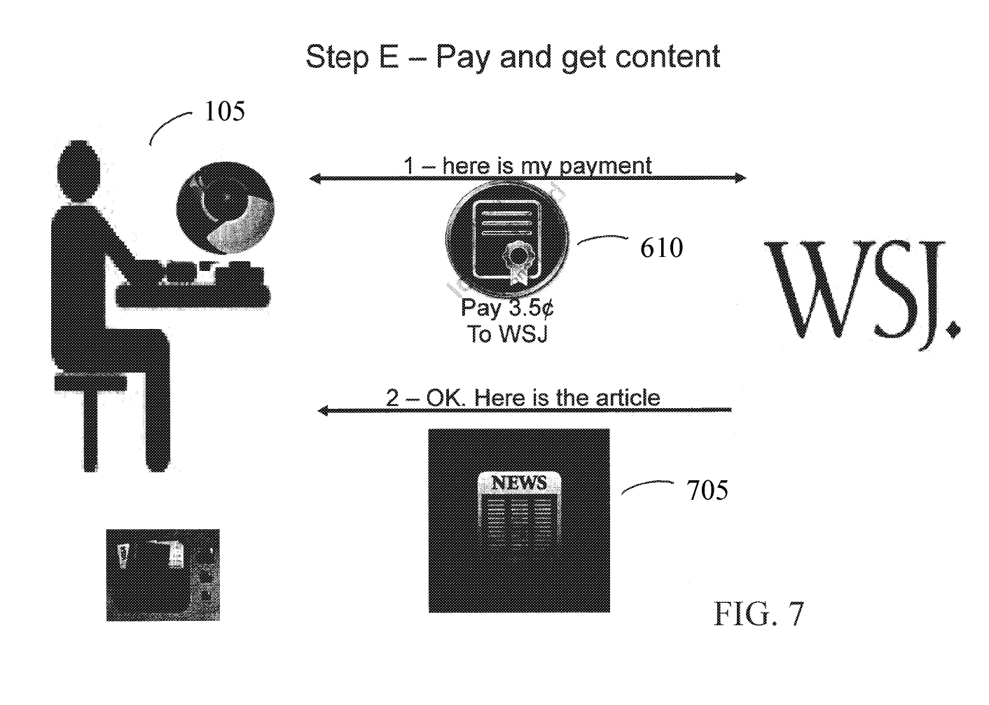

With reference to FIG. 7, the consumer 105 sends the certificate 610 to WSJ. WSJ checks the certificate 610 with the usual X.509 check to confirm the identity and validity of the certificate 610. WSJ then follows the instructions to confirm payment (if necessary). After payment is confirmed, WSJ server can then return the page 705 as requested.

There are many other variations and combinations that are possible.

FIG. 2, shows the process flow for a consumer 105 getting a $5/month coupon from her ISP1. This is just one of many ways the ISP1 can offer this service (like the myriad of plans that are available for cell phone usage and for SMS text messages). It could be a flat fee per month, it could be pay-per-use with minimum, it could be $5/month usage for only $2 charge. Generally speaking, the ISP1 can arbitrarily package it and charge arbitrarily. While this system does not impose limits on the ISP1, there is the limit of whether the consumers will accept it.

Instead of getting her ISP to be the Payment Authority, she could easily get her bank, employer, or any other third-party to act as a Payment Authority. For example, the AMA (American Medical Association) may well want to do this as a benefit for its members. What's more, the AMA can negotiate special deals with certain websites to get discounts. The discounts could be implemented by the content provider specifying multiple prices for the same page—5 cents for AMA, 6 cents for CMA (Canadian Medical Association), 7 cents for everyone else. Alternatively, the price could be 7 cents, but discounts X, Y, Z are applicable. It could even be done without changes at the web site—AMA (as Payment Authority) could certify the 7 cents payment with a note that only 5 cents will be paid pursuant to attached agreement (in this case, the agreements may have to be registered with the Clearing Houses to fully automate this process). The agreements do not have to be per article pricing, they could be bulk pricing, blanket lump-sum access, whatever can be negotiated. In the simplest form, the cost for the node can be specified as an URL. This Cost URL will take a standard list of arguments including the details of the transaction, and it will return a list of the real costs (as if the costs were in the path). In other words, the Cost URL allows delayed evaluation of the actual costs from path construction time to actual use time. The big advantage is that the details of the transaction are available—allow for special deals for particular users, times, weather, world events, etc.

Instead of actual money in the local currency, it is possible for other currencies to be used. For example, loyalty points (say frequent flyer miles) could be used. The Payment Authority could be the airline in question (or some partner thereof) and the coupon would be for the loyalty account. The airline could also act as currency convertor to convert points to actual money. It is also possible for the airline to sign deals with particular content providers (see below).

Instead of the consumer paying for the virtual goods, it is possible for the consumer to get it free. For example, one price that the provider can send back can be 0 cents but will show advertising. This is similar to what some web sites do now, but the consumer is now being offered a choice of whether they wish to pay, or receive advertising.

It is not only the provider that can sell advertising, it is possible for third-parties to do it as well. For example, AA (American Airlines) may want to advertise to people reading about tourist destinations. AA may further wish to tailor advertisements according to the nature or subject of the webpage being viewed, i.e. changing the advertising depending on whether the web page is on Forbes magazine as opposed to Sports Illustrated. AA does this by talking to an ISP with the appropriate footprint—say Verizon. Each time Verizon (as a Payment Authority) is asked to pay to Forbes for an article tagged with “Tourist”, it can send back a path that says “with the compliments of AA” and an URL (Universal Resource Locator). The browser uses the URL to pop up a window showing first class comfort. For Sports Illustrated, the pop up window may show cheap fares. Google Adsense (amongst others) offer some of this functionality, but with those systems, typically the advertiser must go through the Google system or the like (who have agreements with the provider). In contrast, the system of the invention allows third-parties along the payment chain to have this capability.

A further variation is that advertising can offer special deals of an arbitrary nature. This can be implemented by an URL that is returned in the path information.

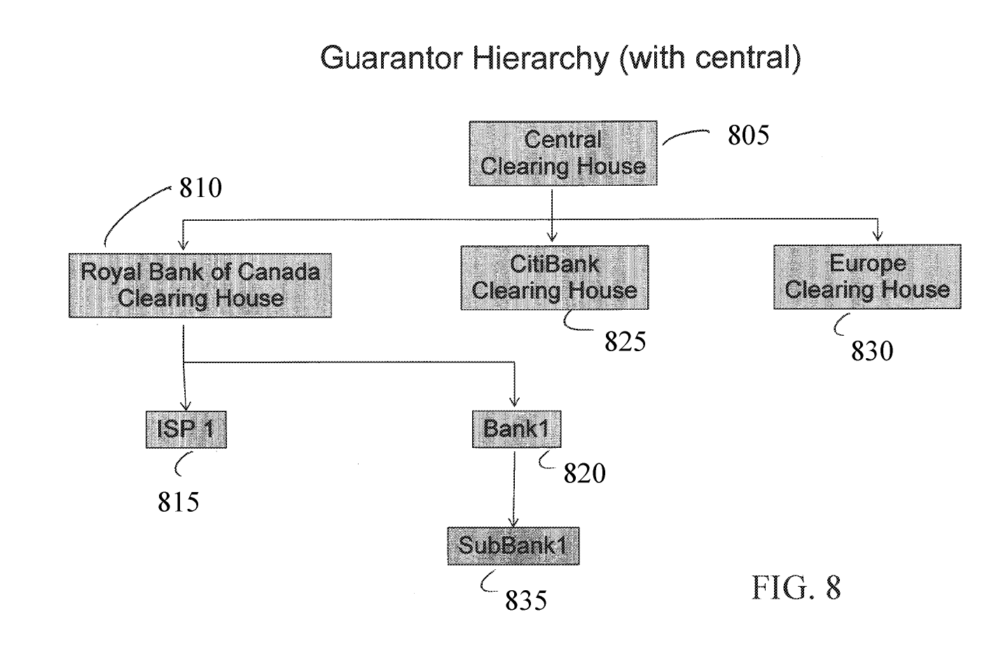

With reference to FIG. 8, the “Central Clearing House” 805 signs a certificate for “Royal Bank of Canada Clearing House” 810 (a Clearing House operated by the Royal Bank of Canada). The certificate can be signed in the usual X.509 way—RBC CH 810 gives its public key and other information to Central CH 805, Central CH 805 fills in the certificate with RBC CH 810 information plus its own information and signs the certificate (with its private key). In turn, RBC CH 810 signs certificates for Payment Authorities ISP1 815 and Bank1 820. In this example, any payment promised by ISP1 is guaranteed by RBC CH 810 (within the statistical limits in the certificate), similarly for payments promised by Bank1.

The Central CH is not necessary, the first tier CH's 810, 825, 830 can just recognize each other (just like normal X.509 where each browser has a list of Certificate Authorities it is willing to recognize). However, when there are many first tier CH's 810, 825, 830, it may be administratively simpler to have a Central CH.

It is entirely possible for Clearing Houses and Payment Authorities to have many layers. For example, FIG. 8 shows Bank1 820 (which is a Payment Authority) signing a certificate for SubBank1 835 (which is also a Payment Authority) that may be called a Sub-PA.

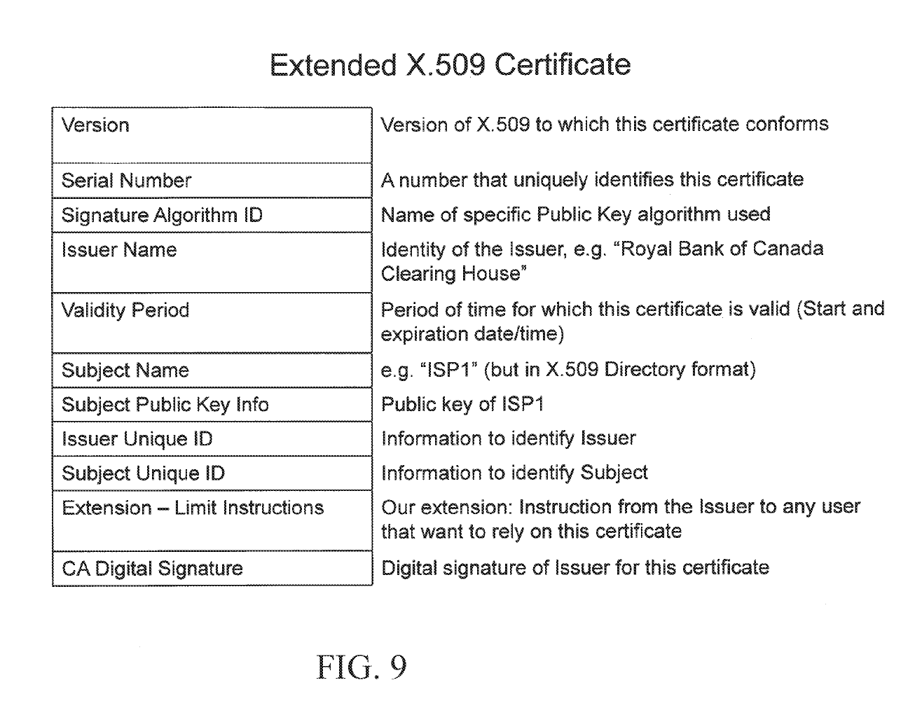

With reference to FIG. 9, the certificate is a standard X.509 certificate with our extension for the Limit Instructions. This certificate is basically a promise by the Issuer (in this example RBC CH 810) to guarantee any payment promised by the Subject (in this case ISP1). It is anticipated that RBC CH 810 may ask for some amount of bond money to be deposited by ISP1 with RBC CH 810 as an assurance of payment.

Clearly, this guarantee is useful only if ISP1 defaults on its promises to pay—in other words, ISP1 has gone rogue and may be wildly issuing promises that it does not intend to keep. Potentially, even with each payments limited to a single penny, ISP1 could issue many promises and run up promises totaling millions of dollars that far exceed any bond on deposit.

Clearly, it would be a huge undertaking for RBC CH 810 to guarantee all promises of ISP1 and RBC CH 810 would likely not make any such guarantee and there is no bond that is large enough to cover the worst case. A central part of this invention is the “Limit Instructions” that curtails the risk to an acceptable extent. The Limit Instructions are put into an Extension (defined in standard X.509). Any user wanting to rely on the Issuer guarantee must follow these instructions for each transaction.

The instructions can be of many forms, the following are typical:
If this Subject or Payment Authority (in this case ISP1) has already made X payments within a time span of Y minutes to this recipient, then this transaction must be validated with the Issuer (in this case RBC CH).
If this Subject has already made payments totaling Z dollars to this recipient, then this transaction must be validated with the Issuer.
Take a hash of the transaction and treat it as a random number. If the random number is divisible by W, then this transaction must be validated.
If this subject had a transaction refused, then all subsequent transaction must be validated. This is enforced by the Recipient/Vendor, but cheating is easily detected since guarantor did the refusing, so any subsequent transaction from the recipient can be detected.

Validating a transaction with the Issuer means the transaction is sent to the Issuer and the Issuer will return Yes or No. This mechanism is designed to give the issuer a chance to stop any rogue Subject/PA from going too wild. For example, the first 2 typical instructions above will serve to limit the amount of money a rogue Subject/PA could move to any particular payee. Any rogue Subject/PA is likely to be in league with a small number of users, so we have in effect limited the total damage by a rogue Subject/PA.

The last 2 typical instructions above allow the Issuer to stop payments to other payees before the limits are reached—further limiting damage.

If a rogue Subject/PA has a huge number of users that are in league; recall that each recipient user must have its own PA, so it is not necessary to chase each rogue user for compensation. One can simply chase the PA with all those rogue users.

For several reasons (loss limiting is one), it is convenient to limit the Validity Period (already present in X.509 standard) to a single day or even shorter. This is in sharp contrast to standard X.509 usage where certificates are typically valid for years. A consequence of this is that certificate handling must be automated—ISP1 must be able to get its daily certificate from RBC CH, and each user from ISP1. Typically, this will be implemented as a, say Web Service, and each user (more accurately, the user's browser when trying to do the first transaction of the day) will present credentials and obtain the certificate. Note that all transactions within the Validity Period are guaranteed by the entities on the certificate path—in the case ISP1, CH1. The fraud limiting mechanisms guarantee payment for validly signed transactions while preventing fraud.

The Limit Instructions can also be used to prevent “money laundering” since money laundering is similar to a rogue PA sending lots of transactions to many different recipients.

For many providers, it would be useful to have very short term subscriptions. For example, the WSJ may charge 3 cents per article, or 25 cents for 10 articles, or $1 for a day up to 100 articles. This could be put into the price options and the consumer can pick. The system can automatically keep track of which package is picked, and which articles were purchased; this can be done very simply by WSJ issuing a Coupon (see FIG. 13) to the customer. In detail, the payment certificate (signed by her ISP say) will be for, say, a package of 10 articles and will result in a coupon being put into her e-wallet. Subsequent articles will be paid for by citing the coupon (without having to get more payment certificates), with sequence numbers like “2 out of 10”, both ends can confirm that there is no overspending. Preferably, their transactions should be signed by the consumer to minimize the risks, but it is up to the consumer (perhaps the computer is too slow). WSJ can be assured the subscription limits are respected since WSJ itself issues the coupon and checks each transaction.

For any transaction, it is recommended that every participating entity have the complete details of the transaction. Primarily this is to make it easy to comply with local laws; but this also makes it possible for each entity to accumulate data on consumers. Given the current state of databases, it is quite possible to store every single transaction and fully index them for quick retrieval. These data can be quite valuable for customer identification and other advertising purposes.

For audits and other reasons, it will be convenient for all transactions to flow back into a central point for safe keeping. For example, this is the point where overspending by a rogue Payment Authority can be detected. This is also the point where we check if payment claim is valid or not (perhaps the confirmation instruction in the certificate was not followed). In most cases, we expect each node (be it Clearing House or Payment Authority or Sub-PA) to maintain its own archive for audit and tax purposes.

It would be pointless duplication for every entity to send all transactions to the central point. Each Payment Authority could simply send all of their payment certificates “up the hierarchy” to their Clearing Houses. The Clearing Houses can then forward to the central point and/or match up the certificates with the payment claims from the providers.

Disputes will happen despite all efforts. One way to resolve the dispute is to do it the way credit cards do—undo the transaction thus refunding the consumer at the merchant's expense. This is administratively expensive and makes for unhappy customer and VERY unhappy merchants. The system of the invention allows a new mechanism where each customer could be allowed a few “no-questions-asked” reversals (where “few” is defined by the Payment Authority and could be something like “up to 3 each month with aggregate value of monthly payment”). A customer can submit the payment certificate to her Payment Authority (or Clearing House, or the Central point) and the payment would be undone WITHOUT taking the money back from the merchant. Of course, statistics will be kept on each customer and merchant as to the number of bad transactions. As soon as a customer/merchant has too many bad transactions, action can be taken—terminating the relationship, raise the monthly fee, raise the handling fee, etc.

### Path Calculation

At first blush, it would appear the Path-finder is a complicated and resource intensive process, so none of the entities will want to provide this service. It turns out that the Path-finder is the key to advertising, so whoever controls it controls making money. The preferred approach is to say that everyone gets to provide this; to simplify terminology, we refer to any entity wanting to do this as a “Payer”. The simplest approach is to let each Payer provide a PFP (Path-finder Portal) and User will treat it's PA as the first Payer, then ask each Payer to get paths and parents, then ask parents to get more paths recursively. This is entirely workable but forces the users to do a lot of queries over the network to a lot of different entities; which means it is likely to be slow.

The recommended approach is to have each PA PFP return paths for itself plus its parent-PA and/or CA all the way up the certificate hierarchy. Since the users only see and deal with PA's, this is the most convenient way for parent-PA and CA to insert their advertising.

Another recommended approach is to leave adverting information out of the payment path, but allow each entity to provide a portal that the User can query for advertising deals.

Clearly, each Payer and its parent must have a protocol for updating the path information. We expect that, typically, the parent will do a daily download of path information (possibly including date ranges—this is especially useful for time-limited advertising). Typically, each entry in a wallet will include the Payer responsible, and the PFP information.

The path calculation may appear daunting, but it is actually quite straightforward. Let's propose some estimates (these are really loose estimates to give the idea of scale, some may be out by factors of ten or even hundreds) on the numbers of the different entities:
National Clearing Houses—these are more or less “national” in scope, but with competition so there may be a few per country. Say there is a thousand in the whole world.
Specialist Clearing Houses—these are the loyalty points and the like, say another thousand.
PA (Payment Authority)—these are equivalent of the big banks, or the big consortiums, probably in the neighborhood of hundreds in major countries and a few in small countries. Totaling ten thousand worldwide.
Payer—these are equivalent of the ISP or local bank. Assuming there are a billion users, there are unlikely to be more than a million sub-PA (otherwise, many sub-PAs will be handling very few users, making them uneconomical).

Since paths are from Payer to Payer, assuming a million Payer's, we are looking at a trillion endpoint pairs, plus the multiplicity of paths (due to currency, etc.) between each pair of endpoints. Potentially, we are looking at hundreds of trillions of paths.

Fortunately, each Payer has a much simpler problem—it only deals with paths with itself as the starting point. It also only needs to handle one currency. For example, ISP1 will only return paths that have ISP1-CH1- . . . and will not have to deal with paths that have Bank1-CH1- . . . which very much simplifies the problem for ISP1. Indeed, ISP1 could just get the entire list from CH1 and forego opportunities for special deals, or ISP1 could just put the PFP for CH1 (see FIG. 13). This means each Payer will only need to worry about the paths to get to each far-end Payer.

If the Payer stores these paths on a relational database, say a table indexed by the far-end Payer, with each row being the list of paths to that Payer. Each path is likely to be under ten entities, each entity takes say a hundred bytes to describe charging, etc. Making each path be under 1K bytes. If we assume, very generously, there are ten paths to each far-end, we are looking at 10K bytes per row. So the table will have a million rows, each of 10K bytes. The whole database is around 10 GigBytes. By modern standards, this is a small database (but probably still requires tuning for optimal performance).

Each Payer (or any other entity) can pre-calculate paths to all end-points and pre-populated the table (say every night after it receives the daily download from its parent PA). It is also possible to calculate the paths on-the-fly and cache the result for subsequent queries. Each Payer can make an independent choice on when to calculate or re-calculate paths.

We also expect that in some cases, the data transfer can be substantial—e.g., asking a PA for its list of Payers could be multi-megabytes. In the interest of efficiency, the protocols could therefore be configured to operate in an “update from version N” or “update from this-date-time” manner.

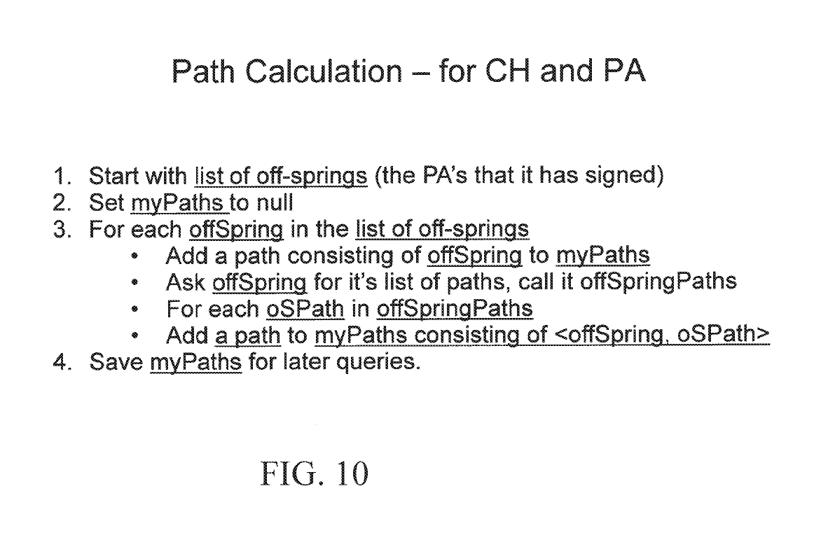

We solve the path calculation problem hierarchically: With reference to FIG. 10, each CH and PA will calculate paths to all other PA. This algorithm will work since the certificate hierarchy is a tree. Each leaf (lowest descendent PA with no sub-PA) will complete this algorithm trivially—it has no paths to anywhere and will return the null or the empty set when asked. Each node (CH or PA) will complete this algorithm if all of its offspring successfully return their respective paths. Since the certificate hierarchy is a tree, this algorithm is guaranteed to converge and complete in finite time. Basically, the leaves will complete first, then paths will bubble up until all the nodes are completed.

Referring again to FIG. 10, each CH and PA will begin by identifying a list of off-springs, that is, a list of PAs that it has signed. The table of paths for the CH/PA is called myPaths; to begin, this table is set to null. For each offSpring in the list of off-springs:
Add a path consisting of “offSpring” to myPaths
Ask each offSpring for its list of paths, calling it offSpringPaths
For each oSPath in the offSpringPaths list:
   Check that offSpring and head of oSPath have compatible currencies (note that a given node may have currency x in, and put currency y out);
   For each compatible currency, add a path to myPaths consisting of <offSpring, currency, oSPath>
      The CH/PA then simply saves the myPaths data in the table or database.

The Clearing Houses are expected to know about each other and the connectivity between each other. This is reasonable since this information does not change often and there are few CH. In any case, each CH must be centrally registered, so this information is easily available.

### General Example, Purchase Execution:

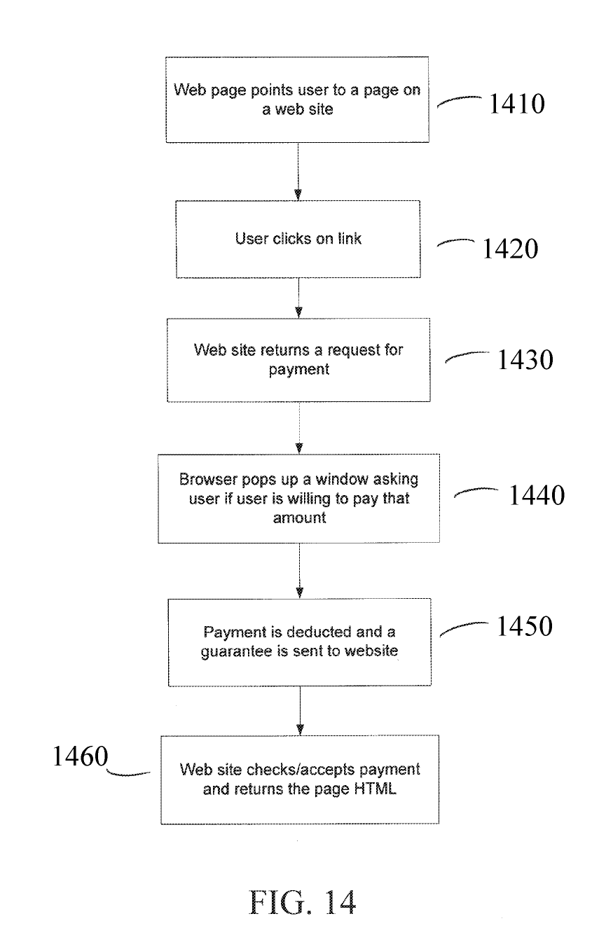

As explained above, the method and system of the invention could be implemented in many different ways. For completeness, several such implementations are described herein after, in greater detail. One such embodiment of the invention could be implemented as follows (see FIG. 14):

1. a search engine (or some arbitrary web page) points user to a page on a web site (1410). Note that, like advertising, the search result could have been a paid-for link on the results page, which is completely independent of the operation of paying for the content.
2. User clicks on link, which means browser does HTTP get (1420).
3. In absence of the system of the invention, the web site returns the page HTML (typically with a HTTP status code of 200 meaning OK). With the system of the invention, the web site returns a request for payment (1430), with specific pricing, say 1 penny USD for the page. The request could be normal HTML with special tag marking it as a payment request, or the request could be a new HTTP status code with associated payment information. There are many ways of doing this.
4. When Browser program receives request for payment, it pops up a window asking user if user is willing to pay that amount (1440).
5. If the answer is yes, the payment is deducted from the User Wallet and a guarantee (probably in the form of a cryptographically signed packet) is sent to web site (1450), typically as another HTTP get, perhaps with a parameter for the payment.
6. Web site checks/accepts payment and returns the page HTML as normal (1460).

For this scenario, it outwardly looks similar to some other payment systems. Most other payment systems stop at this scenario and do not provide any additional functionality, or provide the above using an infrastructure which does not allow the further advantages of the invention to be realized.

### Simple Example, ISP Subscriber:

Most consumers will in fact not pay for a typical transaction directly from their own cash. Nobody wants to handle payments of pennies; and indeed, there is no sensible way to handle payments of fractions of a penny. Most consumers will typically receive bundled deals, either from their ISP (Internet Service Provider), or from some other source. They may, for example, be entitled to spend up to $5 on content as part of their monthly ISP fee. That is:
ISP allows $5 per subscriber per month, but clearly expect the average utilization to be much lower (in the same way that average bandwidth utilization is lower than maximum allowed); and
User has $5 credit (for this month) in her wallet, but this is only credit from ISP, not actual cash.

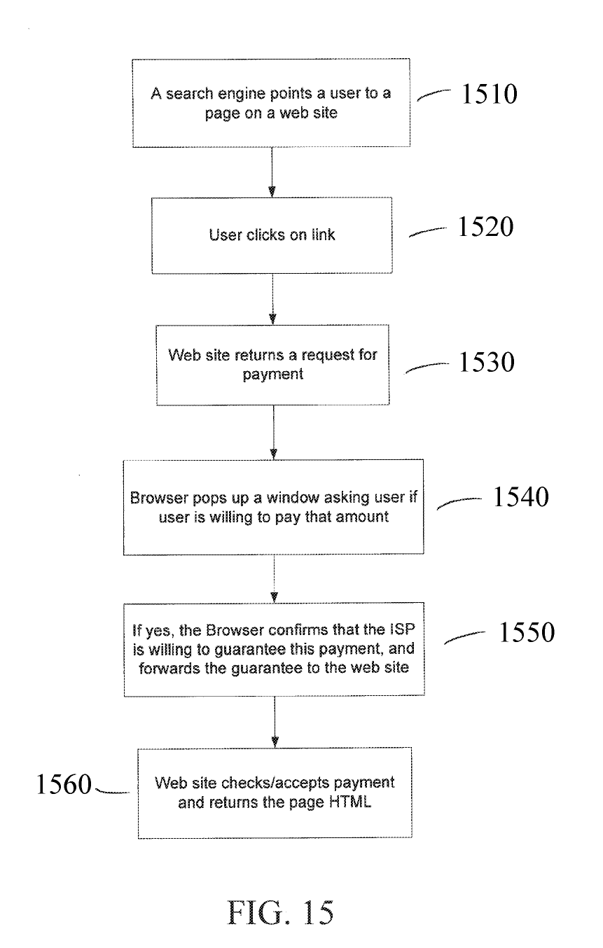

The detailed steps of effecting such a system are as follows, as shown in FIG. 15:

1. as before, a search engine points a user to a page on a web site (1510).
2. As before, User clicks on link, which means their browser does HTTP get (1520).
3. As before the web site returns a request for payment, say 1 penny USD for the page (1530);
4. As before, when Browser program receives the request for payment, it pops up a window asking user if user is willing to pay that amount (1540).
5. New for this scenario. If yes, the Browser confirms that the ISP is willing to guarantee this payment, and forwards the guarantee to the web site (1550). There are many ways to do this—the simplest way is to just forward the payment request to the ISP and receive the guarantee which is then forwarded to the web site. Basically, the web site is receiving payment from ISP, but sending content to user.
6. Web site checks/accepts payment and returns the page HTML as normal (1560).

This scenario is beyond what the competition can do.

### Simple Example, Professional:

For many fields, there are professional associations and other entities that will want to “aggregate” information content. For example, CPA (Certified Professional Accountants) are at the top of the accounting profession in the USA. The AICPA (American Institute of Certified Public Accountants) performs the normal activities that a professional association does, including keeping the members informed about news related to accounting. The AICPA could add a member benefit for access to specialized web contents including some number of journals, newspapers, etc. The AICPA could give each member a credit much like the ISP gives credits to subscribers.

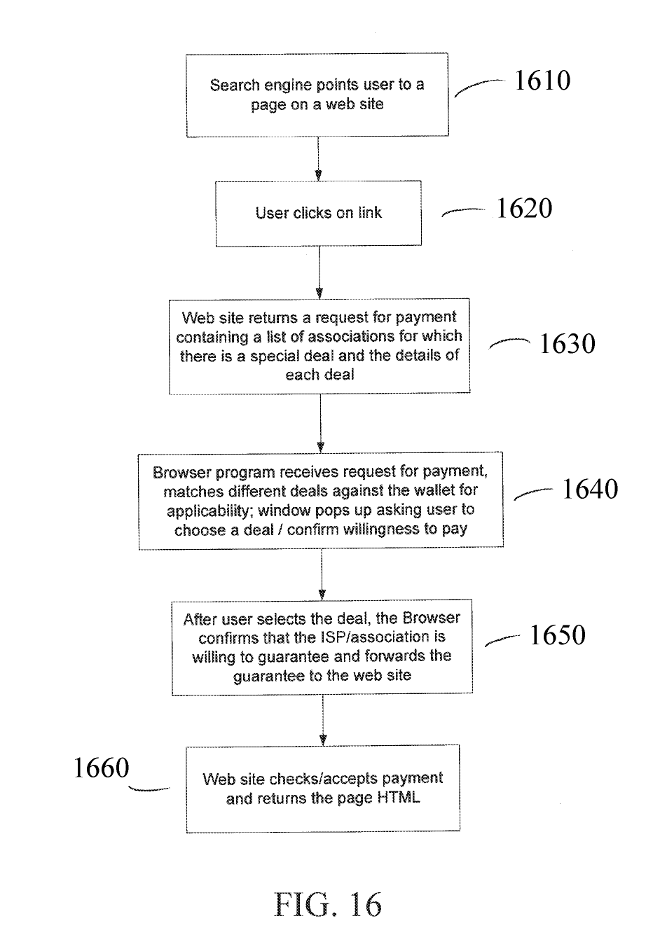

Many consumers will have credits from their ISP as well as one or more professional/specialized associations. This makes the process a little more complicated. As shown in FIG. 16:

1. as before, search engine points user to a page on a web site (1610).
2. As before, User clicks on link, which means browser does HTTP get (1620).
3. New for this scenario, the web site returns a request for payment (1630); say 1 penny USD for the page. The request will also contain a list of associations for which there is a special deal and the details of each deal. The deal could be free unlimited access for members of the associations, or it could be half price for pages, etc.
4. New for this scenario, when Browser program receives the request for payment, it matches the different deals against the wallet and sees which deals are applicable. The browser then pops up a window asking user to choose the desired deal, or confirm willingness to pay that amount (1640).
5. New for this scenario. After user selects the deal, the Browser confirms that the ISP/association is willing to guarantee this payment, and forwards the guarantee to the web site (1650).
6. Web site checks/accepts payment and returns the page HTML as normal (1660).

This scenario is well beyond what the competition can do.

### Multi-Currency:

After all paths are generated, each path is evaluated, each node in a given path receives a “fee” for handling the transaction. The fee for each node is specified by the node—like Visa and MasterCard each can specify how much they want for processing a credit purchase. The request for payment contains the amount of money wanted by the Receiver, the system working backward from that to see how much the payer has to actually pay. The viable paths are presented to the user for selection, allowing the user to choose a desired path, or perhaps setting a default to choose the cheapest path. It is up to each node to decide its fee; but if its fee is high, then users will simply not select any path containing it. This encourages price competition.

There can be multi-currency and different package deals. For example, a request for payment could say:

15 pennies in USD, must clear through sub-PA-US

or 100 Yen JPY, must clear through sub-PA-JP

or 10,000 AAmiles, must clear through sub-PA-AmericanAirlines

or 2 credits from AICPA, must clear through sub-PA-AICPA

Note that the various currencies, loyalty points and fiats will only appear to the consumer if the consumer has a way to pay in those forms. A consumer, for example, may only have bank accounts in U.S. and Canadian currencies, so she will only be offered payment options in those two currencies.

The Payer will look at whether she can get the 2 AICPA credits, and the total cost in USD as the Payer needs to pay (including all transaction fees and currency exchanges). The Payer/user can then pick which path—the choice of whether to use the AICPA credit may depend on the user wanting some AICPA-exclusive content in the future or perhaps it is the end of the month and she will get some more AICPA credits tomorrow. Since the currency is specified at each step of the path, there is no confusion regarding currency.

### Advertising Example

As described above, advertising can be injected into a transaction by different entities. For example:

the content provider can specify the price as “free with advertising” in lieu of charging a fee;

The payer sub-PA-AICPA could insert advertising. For example, BMW USA may want to target CPA's (presumably likely buyers of high-end cars like BMW), but not just any CPA; the company may like to target CPA's looking for information on reviews of cars. Currently, there is no way to do this at all. With the system of the invention, BMW USA could contract with AICPA so that when the sub-PA-AICPA “sees” a transaction for the “right” article, the net cost is calculated to be free (or even a special offer). This special offer could even be conditioned by the membership grade and other information. It is possible that for new CPA's the special offer is for a series 3 BMW, while for long time members (or senior members) the special offer will be for a series 7 BMW. The possibilities are endless.

Just about any other entity can also inject advertising, the only limitation is what the entity knows. Note that entities can accumulate information. For example, the sub-PA-ISP may observe that the reader is particularly interested in a certain subject and insert advertising accordingly.

This (potentially) allows the ISP (and other providers of credit) to build up a comprehensive profile of the users. This profile is much more complete than the profiles from loyalty cards, etc. This may be attractive enough for data aggregators to get into this market.

### Detailed Example

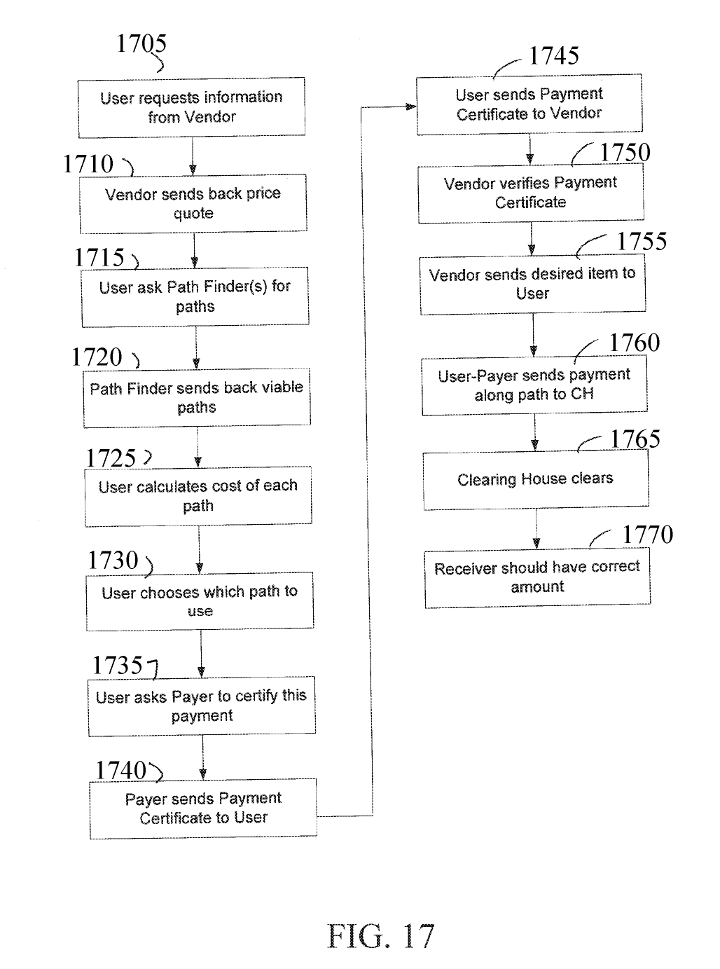

As a detailed example, the message sequence may proceed as follows (see FIG. 17):

1. User requests information from Vendor (1705)
a. something like “get item-URL” via HTTP
b. “item-URL” identifies the exact item of purchase
c. recall that HTTP specifies return IP, desired language[s], desired format[s] and other information
   2. Vendor sends back price quote (1710)

In normal web usage, a “HTTP get” request will get a status code of 200—meaning OK. Sometimes, a status code of 401—meaning unauthorized (along with the WWW-Authenticate Header field) and the user should retry the request with the necessary authentication.

HTTP in fact has a status code of 402—reserved for Payment Required. We can either use 402 (which requires updating the standard) or use 401 (and define our own convention of how the WWW-Authenticate field is structured).

In either case, the price quote will include:
a list of prices in different currencies. Note that the prices for each currency may be wildly different—indeed, some currencies (like airline frequent flyer points) may not convertible to other currencies. Some prices can be strange—“free, but require membership” or anything else.
A list of Payers known to the vendor, including with currencies can be handled by which Payer (and its PA).
   3. User asks Path Finder(s) for paths (1715). This purpose of this step is to find a chain of PA and/or Clearing Houses that starts with the User and ends with the Vendor.

The User receives the payment request (more strictly, the Browser program receives the request on behave of the user)

User will have a “wallet” with a list of their Payers (may be the user's ISP, a professional association, a specialized aggregator like model trains), also including the currencies handled by each Payer.

Send both lists of Payer+currencies to the Path Finder (along with User ID and whatever information the User-Payer will want) [This assumes the Path-finder function is performed by Payer; if other entities are allow, adject accordingly]

4. Path Finder sends back viable paths (1720).

look up (or construct) all possible paths between each User Payer and each Vendor Payer

each possible path must include necessary currency conversion

each component in each path must include the “handling fee” charged by that component. Ideally, the handling fee should be expressed as “+0.2 cents” and/or “+4%” but there is nothing to prevent a more complex language, we are likely to start with just the above two forms plus an escape to a URL. The Escape URL is intended to do things like signing up for a newsletter and can return a return code indicating success or not. The Escape URL should also have a text description of what it does, for example “free if you sign up for newsletter” would be displayed as the cost of this path. When user picks this path, the Escape URL is invoked to sign the user up for newsletter. After the Escape URL returns a magic token, the token is passed to the vendor as proof of signing up.

each possible path should be (cryptographically) signed—we only care about integrity and authentication, so we only need it signed and there is no need to encrypt.

Preferably, the paths can be pre-computed and pre-signed (for simplicity and speed, we may want to break a path into several signed pieces—Payer-to-CH, CH-to-CH, CH-to-Payer). This minimizes CPU time for Path-finder, but means that the actual cost calculation must be done by user.

possibly insert additional paths for third party advertising and such

send list of possible paths back to User

5. User calculates cost of each path (1725)

After the User has the list of possible paths (either from Path Finder or Clearing Houses), they may review each path to evaluate “actual cost” and possible advertising deals.

A path is something like: User→Payer-Verizon→PA-CitiBank→CH-USA→CH-Canada->PA-RoyalBank→Payer-RB-Vancouver→Vendor. In this case, the user is relying on her ISP (Verizon), Verizon routes all the payments through CitiBank, which in turn clears through the national clearing houses, finally going to the Vancouver branch of Royal Bank with handles payments for the Vendor.

In each path, each entity in the path is assigned the in-currency and the out-currency. That is, the Path Finder may decide on who will do which conversion; this means each entity must specify to the Path Finder its charge for currency conversion (including the conversion rate, which should be periodically updated by each entity) and the Path Finder will pick the lowest total cost. This feature is necessary to keep possible paths down to a manageable level—otherwise the number of paths may grow exponentially with the number of currencies involved).

Alternatively, currency conversion is not part of the path. Each component specifies the conversion rate for conversions that it will performs. The user browser is then responsible for picking the currencies conversion as will. This further reduces the work of the Path-finder but increases the work for the browser.

Each entity also must publish its charge for handling the transaction. The charge can be a fixed cost, say ½ cent USD, or a percentage, say 10%. In some cases (promotions, advertising, etc.) it could be −100% meaning user pays nothing and the advertiser pays the whole cost to the Vendor; or it could be even −100%−5 cents which means not only is it free to the user, the user actually gets paid 5 cents!

The User (actually the Browser/plugin) calculates the cost for a path by starting at the Vendor end with the desired price, go through the path hop by hop. At each hop, follow the published charge for that entity (currency conversion rate should be include in the path already).

Some paths may be “funny” in that the user is paid money (see above) or it may be free but requires signing up to a mailing list or whatever.

6. User chooses which path to use (1730)

Present the choices to the User—this is to let the user select which path (implicitly selecting currency and Payer) and to confirm that the transaction should go ahead.

This can be by a pop-up window, or it could be controlled by pre-configured settings like “All NY Times prices below 5 cents can go ahead”, “request under 1 cent from the ISP package can go ahead” etc.

This can be very simple or complex and is entirely under the control of the Browser program. So novice users will not have to understand the complexities while power users can have all the controls.

7. User Asks Payer to Certify this Payment (1735)

After User picks a path, User has to send a request to her Payer to certify this payment.

The request will consist of the item-URL, the path, and User ID (or whatever the Payer needs to authenticate the user). This identifies what-is-bought, who-bought-it, who-will-pay, how-the-money-moves.

8. Payer sends Payment Certificate to User (1740)

The Payer performs its own business logic to decide if the User is authorized to spend this money, etc. If so, the Payer signs the transaction with the above information—this act certifies that the Payer will pay the amount to the next link in the chain. (If the Payer fails to pay, the PA up-the-hierarchy is responsible up to the big Clearing House)

9. User sends Payment Certificate to Vendor (1745)

After receiving the signed transaction, just send it to Vendor as part of the new HTTP get request.

10. Vendor verifies Payment Certificate (1750)

Vendor receives the signed Payment Certificate and checks
the signature by the Payer
the certificate of the Payer has not expired.
In order to guarantee payment, we probably want to have a lot of limits on a Payer certificate—a combination of short expiry time, small limit per transaction, limit on total transactions per day per vendor. This limits the damage caused by a rogue PA since the PA can only defraud each vendor by a limited amount before action by the parent-PA.
Alternative security check is something like:
   hash the payment certificate (this is to make sure the whole certificate contributes to the hash key)
   some percentage of hash values (say all hash values divisible by 10) means the payment certificate should be confirmed with parent-PA (this is possibly part of Payer Certificate signed by parent-PA). The parent-PA is free to use any business logic to decide if the Payer has “turned rogue” or not. Some Vendors may decide to verify a higher percentage for high value transactions.
   As a variation, it is possible to require the Payer to check the hash value and ask its parent-PA to sign the Payment Certificate. This makes it simpler on the user.
   This has the advantage that only bad Payers need to be tracked by the vendor, and the damage limit can be adjusted by varying the sampling percentage. Assuming the average transaction is 1 penny, then a sample rate of 0.001 means each vendor will lose only $10 on average. Or a sampling rate of 0.01 means a maximum possible loss of $1 on average.
      11. Alternatively, the Vendor passes the Payment Certificate to the Vendor-Payer, and the Vendor-Payer does all this checking (not shown in FIG. 17). This has the advantage that the Payment Certificate must be passed to the Vendor-Payer anyway, so it might as well do the checking—especially since it is responsible to collect.
      12. Vendor sends desired item to User (1755). At this point, the Vendor should be happy since payment has been guaranteed and can now do whatever processing is required to serve the content or other products to the User.
      13. User-Payer sends payment along path to CH (1760)

At some agreed upon time (weekly, daily, real-time, what-ever), payment is launched into the path by the first PA in the path (by definition, the PA that guaranteed the payment).

The first PA sends the signed transaction to the first CH in the path (possibly as a big batch of transactions all with the CH).

It should also do its own internal account to bill the User (and it could be free, part of a package, or whatever).

14. Clearing House clears (1765)

At agreed upon times, or enough received transaction, or whatever trigger is used, the Clearing Houses starts to clear the transactions.

The first step is for each CH to forward transactions to the next hop CH (there may be multiple CH in the path)

After every CH has forwarded all its transactions, each CH has every transaction that includes it.

Each CH can now compute how money should move (and in what direction) between it and its peers.

Each CH communicates with peers to confirm that every agrees.

If not, the two CH's can compare list of transactions. Since transactions are signed, it should be simple matter to resolve.

If confirmed, money flows between CHs.

The first and last CH in the path calculate the money for their PA and sub-PA (in both directions)

Net amount is moved

15. Receiver should have correct amount (1770)

The Receiver should receive the correct amount.

The CH or PA should be able to provide the list of transactions cleared.

The Receiver should be able to reconcile its own list against the provide list.

With this, the process is complete, and all parties are satisfied.

### Exemplary Performance Statistics:

Some exemplary technical measures are as follows:

A 2048 bit RSA signature takes 6 milli-seconds on AMD Opteron 8354 at 2.2 GHz from 2009 (see http://www.cryptopp.com/benchmarks.html). We can safely assume that on 2013 processors, a signature will take a single milli-second. Note that verifying the signature takes much less work—assuming each entity will perform a signature is a very conservative estimate.

For Amazon EC2, a “High-CPU Reserved Instance” is 36 cents per hour for “Extra Large” (for US East data center) which works out to 0.01 cent per second. Which means a RSA signature costs 10 micro-cents. This means we can over-provision CPU by a factor of 100 and it will still only cost us 1 milli-cent per signature.

EC2 bandwidth is around 2 cents per GB (average of different plans and datacenters). Assuming each transaction will take 2K bytes:
1000 bytes URL to identify the exact item being bought
100 bytes of addressing and payment details for each entity
10 entities in the transaction

The cost is then 500K transaction in a single GB, or 4 micro-cents per transaction each way

So, the cost to processing a single transaction is under 20 micro-cents for each of the entities in the chains. The total cost for all entities is well under ½ milli-cent.

EC2 storage is around 25 cents per GB per month. Each transaction is 2 KB, so it will cost 12 micro-cents per transaction per month, or 0.3 milli-cent per transaction per year. Beyond that, archival storage should be even cheaper.

So, assuming all ten entities want to store the transaction, we are looking at total system-wide cost of well under 5 milli-cents to fully process a transaction and store it for a year (in ten locations!).

For the Payer Portal, one EC2 instance can handle 3.6 million requests per hour (60 minutes*60 seconds*1000 mill-seconds) and should be adequate for a user base of say one million—depending on how many users are on-line and active at any time. Certainly a single CPU instance should be enough on a small to medium size ISP. As the software is easily parallelizable, more CPU instances can be turned on as needed.

### Advantages

The system and method of the invention provides many advantages over known systems. For example:

1. System is “consumer aggregated” in the sense that consumers know whom to pay and how much to pay. It is a Single Point of Payment as opposed to paying each provider separately. This is a prerequisite for efficient operation of the system, and is a prerequisite for User-Friendliness. In other words, I am willing to pay $4.23 for this month, but I am not willing to pay hundreds of bills each of 1 penny or two.
User can pay sub-PA in a net bill (like a credit card bill)
User can also get credits from ISP or other associations, possibly as part of bundles;
   2. System is “provider aggregated” in the sense that providers know from whom to collect and how much to collect. Single Point of Payment is necessary for the same reasons above. The web site does not want to collect pennies, instead, the web site wants to have someone else collect all the pennies and just give a single cheque to the web site. Through aggregation, customer costs come down significantly, even for those requiring credit card input of currency;
   3. System has an audit trail. Even though the transactions are tiny, the aggregated payments must be resolvable to each transaction, and each transaction must authenticate to each payer/payer with complete traceability. This is easily accommodated with the system described;
   4. System is not anonymous. Even though this system targets tiny transactions, there is nothing limiting the size or the number transactions; so aggregate size may be substantial. This means there is potential for money laundering, so each transaction must be traceable to payer and payee. This may be “against the grain” for many researchers into payment systems, but we must avoid the large legal minefield. Since all payments are done through PA/sub-PA, we can identify Payer and Receiver to the sub-PA. It is then up to the sub-PA to satisfy local laws, customs and business practices.
   5. Since transactions will typically happen first, then money move later (by hours or days), we guarantee that money will move. Again, each individual transaction may be small, aggregates will be large. It is up to each PA to guarantee its sub-PA. This may translate to PA and sub-PA posting performance bonds, and a more complex design in the traceability and/or authorization of each transaction.
   6. By design of the system, competition is encouraged at every level (except at the Clearing House level) and the competition is not just that there are competitors but each transaction is a mini-competitive bidding selection process.
   7. Each user can have many different credits in her wallet—one from ISP, one for general news, one for professional interest, one for a hobby, etc. This system makes it easy to handle many credits and still take optimal advantage of the different attributes of each credit. Having flexible and alternate ways to input currency into the system allows users to leverage loyalty currency as well as direct carrier billing;
   8. By leveraging and modifying the traditional retail model along with the credit card model and the Certificate Authority model, we have come up with an unique design that works well, scales to world-wide deployment and yet meets all requirements;
   9. Deployment and market acceptance can be gradual. Each jurisdiction can decide whether it wants competition—if yes, just allow multiple PAs. If not, just allow a single PA. It can join the Clearing Houses that it wants. There is no need to have the whole world convert at the same time;
   10. as noted above, none of the None of the big 4 are frictionless: all of them require several clicks to perform a purchase. In contrast, with the system of the invention, you will have pre-arranged agreements with vendors that will allow you to either to have immediate access to content or virtual goods due to the fact you have pre-paid or have credit in some form to do so;
   11. Truly Global: our proposed solution will allow virtually anyone, anywhere, the ability to buy content or virtual goods regardless of their geographic location, in their own currencies available to them, both loyalty and fiat currencies;
   12. Inherent Auction Capabilities: will create more opportunities for partners in our payment ecosystem as they compete for settling of transactions;
   13. Better Control over advertising content: our system will allow customers better tailored advertising and revenue;
   14. Better control over fraud via our patent pending automated hierarchical statistical limit setting: most solutions today are post sale, i.e., deal with the fraud issue after it already happens whereas we intend on more granular control upfront, before the sale even happens; and
   15. Larger Ecosystem: the system of the invention is focused on providing a global system for the purchase of global content and virtual goods. This focus will: 1) provide more vendor partners as well as 2) financial partners that will benefit in the ecosystem;

### CONCLUSIONS

The present invention has been described with regard to one or more embodiments. However, it will be apparent to persons skilled in the art that a number of variations and modifications can be made without departing from the scope of the invention as defined in the claims.

The method steps of the invention may be embodied in sets of executable machine code stored in a variety of formats such as object code or source code. Such code may be described generally as programming code, software, or a computer program for simplification. Clearly, the executable machine code or portions of the code may be integrated with the code of other programs, implemented as subroutines, plug-ins, add-ons, software agents, by external program calls, in firmware or by other techniques as known in the art.

The embodiments of the invention may be executed by a computer processor or similar device programmed in the manner of method steps, or may be executed by an electronic system which is provided with means for executing these steps. Similarly, an electronic memory medium such as computer diskettes, hard drives, thumb drives, CD-Roms, Random Access Memory (RAM), Read Only Memory (ROM) or similar computer software storage media known in the art, may be programmed to execute such method steps. As well, electronic signals representing these method steps may also be transmitted via a communication network.

All citations are hereby incorporated by reference.

What is claimed is:

1. A method of electronic payment between a payer and a payee comprising:
generating a secure electronic transaction by a payer device, the secure electronic transaction including a payment certificate having an extension setting out transaction rules;
routing the secure electronic transaction through a payment path of network entities from the payer device to a payee device, particular ones of said network entities adding a respective payment certificate to the secure electronic transaction, each of said respective added payment certificates having an extension setting out transaction rules; and
receiving the secure electronic transaction at the payee device, including the payment certificates from each of said network entities in the payment path.

2. The method of claim 1 wherein the payment path is a selected payment path.

3. The method of claim 2 wherein each of the particular ones of said network entities adding a respective certificate to the secure electronic transaction comprises a network entity on a separate level of the selected payment path hierarchy.

4. The method of claim 3, wherein the steps of generating and routing are executed in response to a request for electronic payment being received.

5. The method of claim 3, further comprising:
determining available payment paths between the payer associated with a customer, and the payee associated with a supplier, each of said available payment paths having a hierarchy; and
responding to selection of one of the available payment paths by the customer, by routing the secure electronic transaction through the selected payment path, the secure electronic transaction collecting a certificate from each entity in a given level of the hierarchy of the selected payment path, each of the certificates including an extension setting out transaction rules.

6. The method of claim 5, further comprising calculating and advising the payer of a cost for each of the available payment paths.

7. The method of claim 1, further comprising a Vendor performing a check of a predetermined percentage of received signed Payment Certificates.

8. The method of claim 1, wherein a payment certificate effects a subscription management agreement by allowing a predetermined number of transactions in a given time period.

9. The method of claim 1, wherein a payment certificate effects a subscription management agreement by allowing a predetermined value of transactions in a given time period.

10. The method of claim 1, wherein fraud is controlled by specifying value limits on accumulated transactions between the payer and the payee.

11. The method of claim 1, wherein fraud is controlled by specifying a limit to the number of accumulated transactions between the payer and the payee.

12. The method of claim 1, further comprising controlling money laundering by maintaining traceability of the transactions, and by specifying limits to the number and total value of accumulated transactions between the payer and the payee.

13. The method of claim 1, further comprising:
establishing a hierarchy of entities between a consumer associated with the payer and a product supplier associated with the payee;
determining available payment paths from the consumer to the product supplier over the hierarchy by each entity recursively:
identifying each adjacent entity in the hierarchy;
reporting each adjacent entity back to its respective parent entity;
collating received adjacent entity data at the consumer, to determine available payment paths; and
executing electronic payment between the consumer and the product supplier, via a selected one of the available payment paths.

14. The method of claim 1, further comprising the steps of:
establishing a hierarchy of entities between a consumer associated with the payer and a product supplier associated with the payee;
determining available payment paths and transaction costs from the consumer to the product supplier over the hierarchy of entities by recursively:
identifying each adjacent entity in the hierarchy;
requesting each adjacent entity to identify their adjacent entities, and the cost per transaction; and
reporting each of these adjacent entities and transaction costs back to the parent entity;
collating received adjacent entity and transaction costs data on the consumer, to determine available payment paths and a transaction cost per path;
selecting one of the available payment paths; and
executing electronic payment between the consumer and the product supplier, via the selected one of the available payment paths.

15. The method of claim 1, wherein the payer is associated with a payer device and the payee is associated with a payee device, the method further comprising:
generating a secure electronic transaction by the payer device, the secure electronic transaction including a certificate having an extension setting out transaction rules;
routing the secure electronic transaction through a payment path of network entities from the payer device to a payee device, the payment path being determined by:
recursively asking adjacent entities in the hierarchy to report on their respective adjacent entities, back to their respective parent; and
collating received adjacency data to determine available payment paths; and routing the secure electronic transaction via a selected one of the available payment paths; and receiving the secure electronic transaction at the payer device.

16. The method of claim 1, further comprising:
establishing a hierarchy of entities between a consumer associated with the payer and a product supplier associated with the payee;
determining available payment paths from the consumer to the product supplier over the hierarchy;
calculating a cost for each of said available payment paths; and
executing electronic payment between the consumer and the product supplier, via a selected one of the available payment paths.

17. The method of claim 16 wherein selecting one of the available payment paths comprises the consumer selecting one of the available payment paths.

18. The method of claim 16 wherein selecting one of the available payment paths comprises selecting one of the available payment paths by a default process.

19. The method of claim 16, wherein currency conversion is effected by the entities in the available payment paths.

20. The method of claim 16 wherein currency conversion is effected by a browser on a consumer device.

21. The method of claim 16 wherein the cost for a given entity in the hierarchy is selected from the group consisting of a monetary fee, a fiat, loyalty points and a virtual currency.

22. The method of claim 16 wherein the cost for a given entity in the hierarchy further comprises conditions on use of the content.

23. The method of claim 16 wherein the cost for a given entity in the hierarchy comprises a requirement that the customer view an advertisement rather than being charge a monetary fee.

24. The method of claim 16 wherein the cost for a given entity in the hierarchy comprises a requirement that the customer view an advertisement supplied by a third party.

25. The method of claim 16 wherein determining available payment paths and calculating the cost comprises:
determining available payment paths and calculating the cost, on a periodic basis, independent of any particular request to process a transaction; and
caching the available payment paths and their respective calculated costs.

26. The method of claim 25, wherein determining available payment paths and calculating the cost are performed on a daily basis.

27. The method of claim 25 wherein determining available payment paths comprising determining available payment paths using a Path-Finder Portal.

28. A system for electronic payment between a payer and a payee comprising:
a payer device;
a payee device; and
a network interconnecting the payer device and the payee device;
the payer device being operable to:
generate a secure electronic transaction, the secure electronic transaction including a certificate having an extension setting out transaction rules;
route the secure electronic transaction through a payment path of network entities from the payer device to a payee device, over the network, particular ones of said network entities adding a respective certificate to the secure electronic transaction, each of said respective added certificates having an extension setting out transaction rules; and
the payee device being operable to receive the secure electronic transaction, including the certificates the particular ones of said network entities in the payment path.
